(19) United States
(12) Patent Application Publication
(10) Pub. No.: US 2007/0006494 A1
(43) Pub. Date: Jan. 11, 2007

(54) SYSTEMS AND METHODS FOR TRACKING LIVESTOCK

(76) Inventors: Norman J. Hayes, Billings, MT (US); Rodney J. Hayes, Cody, WY (US)

Correspondence Address: FAEGRE & BENSON LLP;PATENT DOCKETING, 2200 WELLS FARGO CENTER, 90 SOUTH SEVENTH STREET, MINNEAPOLIS, MN, 55402-3901, US

(21) Appl. No.: 11/428,799

(22) Filed: Jul. 5, 2006

Related U.S. Application Data
(60) Provisional application No. 60/697,215, filed on Jul. 6, 2005.
(60) Provisional application No. 60/721,139, filed on Sep. 26, 2005.

(51) Int. Cl. G09F 3/00

(52) U.S. Cl. 40/301

(57) ABSTRACT

According to various embodiments of the present invention, an ear tag having a tag portion, a flexible connector portion rotatably coupled with tag portion on one end and with a keeper portion on the other end, and a piercing portion configured to engage keeper portion, the piercing portion including a cutting edge for insertion through animal's ear. According to some embodiments, an ear tag with tag portion, flexible connector portion rotatably coupled to the tag portion at one end, the other end configured to pierce an ear, and locking clip configured to engage the other end on a side of the ear opposite from the tag portion. According to embodiments of methods, providing a tag having a pierce receptacle rotatably coupled thereto and a pierce having a sharpened hollow end, pushing pierce through an ear in a trough between two cartilage bands, and coupling the pierce with the pierce receptacle.

### CROSS-REFERENCE TO RELATED APPLICATIONS

This application claims the benefit of U.S. Provisional Patent Application Ser. No. 60/697,215, entitled “Systems and Methods for Tracking Livestock,” and filed on Jul. 6, 2005, and of U.S. Provisional Patent Application Ser. No. 60/721,139, entitled “Systems and Methods for Tracking Livestock,” and filed on Sep. 26, 2005. The aforementioned applications are both incorporated by reference herein for all purposes.

### BACKGROUND

1. Field

Embodiments of the present invention relate generally to ear tags for livestock, and more particularly to rotating, flexibly connected ear tags for livestock.

2. Description of Related Art

Applying tags to livestock enables those engaged in livestock management to label their livestock and collect data about their livestock in a more systematic fashion. With respect to many breeds of livestock, an ear tag may be applied for identification and/or tracking purposes. Current ear tags are often more susceptible to disengagement from the ear due to a lack of long-term durability and/or an ineffective attachment to the ear. For example, current ear tags often do not permit rotation and/or swiveling in multiple planes and directions, thus causing the tag to break and/or the ear to tear when the tagged animal applies force to the tag by, for example, brushing up against a fence. Current ear tags may also lead to a higher infection rate for these reasons. Current ear piercing instruments for engaging a tag may also lead to a higher infection rate because they often puncture and spread the flesh rather than cutting relatively cleanly through it. Furthermore, current ear tags often lack hollow portions which are configured to interchangeably house electronic components for livestock tracking. Therefore, there is a need in the art for improved systems and methods for tracking livestock via ear tag systems.

### BRIEF SUMMARY

An ear tag according to embodiments of the present invention may include a tag portion, a flexible connector portion with a first end and a second end, the first end rotatably coupled to the tag portion, a keeper portion rotatably coupled to the second end, and a piercing portion configured to engage the keeper portion, the piercing portion comprising a cutting edge for insertion through an ear of an animal. In some instances, the animal may be bovine. According to some embodiments, the flexible connector portion is a ball chain, and the ball chain is configured to permit flexing and/or to permit rotation and swiveling of the ball chain with respect to the tag portion and the keeper portion. According to other embodiments, the flexible connector portion is a cable. According to some embodiments, the ball chain can carry at least 125 pounds of axial tension.

In some instances of the embodiments of the ear tag, the tag portion includes a hollow portion, which may be configured to receive an electronic device; for example, the electronic device may be an electronic tracking system, a battery, and/or an electronic chip. In other instances of the embodiments, the piercing portion further comprises a head, which may be contoured to the ear and configured to disperse a force applied to the ear tag over an area of the ear, and a shaft portion, the shaft portion including a head end and a cutting end, with the head end connected to the head and the cutting edge formed on the cutting end. Such instances of the embodiments of a piercing portion may further include a lip formed on the shaft portion and configured to engage a collar on the keeper portion. According to some embodiments of the piercing portion, the cutting end is hollow, and one side of the cutting edge may protrude further from the head than another side of the cutting edge. The cutting edge may be a sharpened circumference of the shaft portion, and may be configured to cleanly remove a circle of flesh from the ear.

In yet other instances of the embodiments of the ear tag, a bar code or a number may be applied to the tag portion. For a tag made of resin, a bar code and/or a number may be laser marked onto the resin. The tag portion may include a ball chamber, and one end of the flexible connector portion may be rotatably coupled with the tag portion via the ball chamber. The keeper portion may also include a second ball chamber, and the other end of the flexible connector portion may be rotatably coupled with the keeper portion via the second ball chamber.

Another ear tag according to embodiments of the present invention may include a tag portion, a flexible connector portion with a first end rotatably coupled to the tag portion and a second end configured to pierce an ear, and a locking clip configured to engage the second end on a side of the ear opposite from the tag portion. According to some embodiments, the locking clip includes a fluted cone for facilitating placement of the second end through the ear and through the locking clip. The second end may further include a toggle, and the locking clip may further include a groove for engaging the toggle. According to some embodiments, the locking clip includes a first half and a second half, the toggle configured for insertion through the first half and retention between the first half and the second half. In some cases, the second half may have a toggle pocket, and the second half may slide over the first half to retain the toggle within the toggle pocket between the first half and the second half. In some instances of the embodiments, the locking clip includes a battery and/or a temperature chip.

Methods for attaching an ear tag to a bovine according to embodiments of the present invention may include providing a tag having a pierce receptacle, the pierce receptacle rotatably coupled to the tag, providing a pierce having a hollow end, the hollow end sharpened around its circumference, pushing the pierce through an ear of a bovine at a location on an inside of the ear in a trough between two bands of cartilage, thereby cutting a hole through the ear with the hollow end, and then coupling the pierce with the pierce receptacle. According to some instances of the embodiments, the pierce includes a protruding lip, and coupling the pierce with the pierce receptacle includes engaging the protruding lip with the pierce receptacle. The pierce receptacle may also include a collar, and engaging the protruding lip with the pierce receptacle may further include engaging the protruding lip with the collar. In some cases, the pierce may taper from the hollow end to the protruding lip, and engaging the protruding lip with the collar may include pushing the hollow end through the collar to expand the collar until the protruding lip passes through the collar.

This summary provides only a general outline of some embodiments of the present invention. Many other objects, features, advantages and other embodiments of the present invention will become more fully apparent from the following detailed description and the accompanying drawings.

### BRIEF DESCRIPTION OF THE DRAWINGS

A further understanding of the various embodiments of the present invention may be realized by reference to the figures which are described in remaining portions of the specification.

FIG. 1 illustrates a front elevation view of an ear tag according to embodiments of the present invention.

FIG. 2 illustrates a side elevation view of the ear tag of FIG. 1 according to embodiments of the present invention.

FIG. 3 illustrates an exploded perspective view of the ear tag of FIGS. 1 and 2 according to embodiments of the present invention.

FIG. 4A illustrates a perspective view of an alternative ear tag configuration according to embodiments of the present invention.

FIG. 4B illustrates a perspective view of the ear tag of FIG. 14A with an open compartment according to embodiments of the present invention.

FIG. 5 illustrates a front elevation view of the ear tag of FIG. 4 according to embodiments of the present invention.

FIG. 6 illustrates a side elevation view of the ear tag of FIGS. 4 and 5 according to embodiments of the present invention.

FIG. 7 illustrates a perspective view of a pierce according to embodiments of the present invention.

FIG. 8 illustrates a front elevation view of the pierce of FIG. 7 according to embodiments of the present invention.

FIG. 9 illustrates a side elevation view of the pierce of FIGS. 7 and 8 according to embodiments of the present invention.

FIG. 10 illustrates a side cross sectional view of the pierce of FIGS. 7-9 taken along line A-A of FIG. 8, according to embodiments of the present invention.

FIG. 11A depicts an inside of a cow's ear illustrating a placement of the ear tag of FIGS. 4-6 as applied to the ear, according to embodiments of the present invention.

FIG. 11B depicts an outside of a cow's ear illustrating a placement of the ear tag of FIGS. 4-6 as applied to the ear, according to embodiments of the present invention.

FIG. 12 illustrates a perspective view of yet another alternative ear tag according to embodiments of the present invention.

FIG. 13 illustrates a perspective view of a ball and socket joint of the ear tag of FIG. 12 according to embodiments of the present invention.

FIG. 14 illustrates a perspective partial cut-away view of a locking clip of the ear tag of FIG. 12 according to embodiments of the present invention.

FIG. 15 illustrates a perspective view of a ball portion of the ball and socket joint of FIG. 13 according to embodiments of the present invention.

FIG. 16 illustrates a perspective view of an ear tag with an alternative locking clip according to embodiments of the present invention.

FIG. 17 illustrates a perspective view of the locking clip of the ear tag of FIG. 16 according to embodiments of the present invention.

FIG. 18 illustrates a perspective view of an ear tag with another alternative locking clip according to embodiments of the present invention.

FIG. 19 illustrates a perspective view of the ear tag of FIG. 18 according to embodiments of the present invention.

FIG. 20 illustrates a flow diagram of a method for applying an ear tag to an ear according to embodiments of the present invention.

### DETAILED DESCRIPTION

Embodiments of the present invention relate generally to ear tags for livestock, and more particularly to rotating, flexibly connected ear tags for livestock. Such embodiments may solve problems of tag retention in livestock herds by reducing the numbers of lost tags and the damage to animals caused by the tags.

As used herein, the term “coupled” is used in its broadest sense to refer to elements which are connected, attached, and/or engaged, either directly or integrally or indirectly via other elements, and either permanently, temporarily, or removably. As used herein, the term “swivelably coupled” is used in its broadest sense to refer to elements which are coupled in a way that permits one element to swivel with respect to another element. As used herein, the term “rotatably coupled” is used in its broadest sense to refer to elements which are coupled in a way that permits one element to rotate with respect to another element. For example, rotational coupling may be achieved with a ball-and-socket type joint. As used herein, the term “slidably coupled” is used in its broadest sense to refer to elements which are coupled in a way that permits one element to slide or translate with respect to another element.

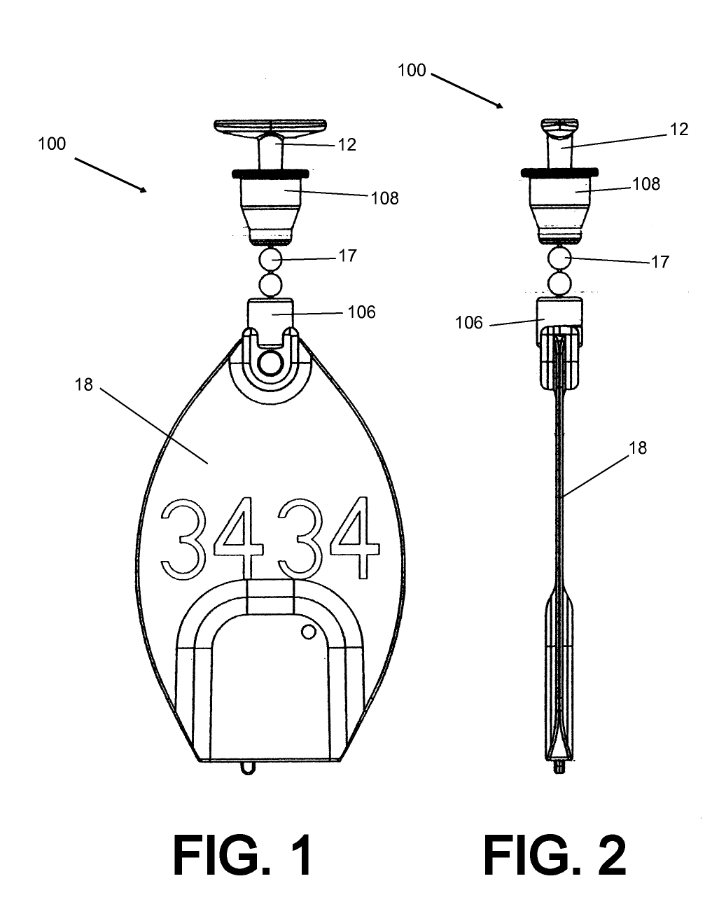

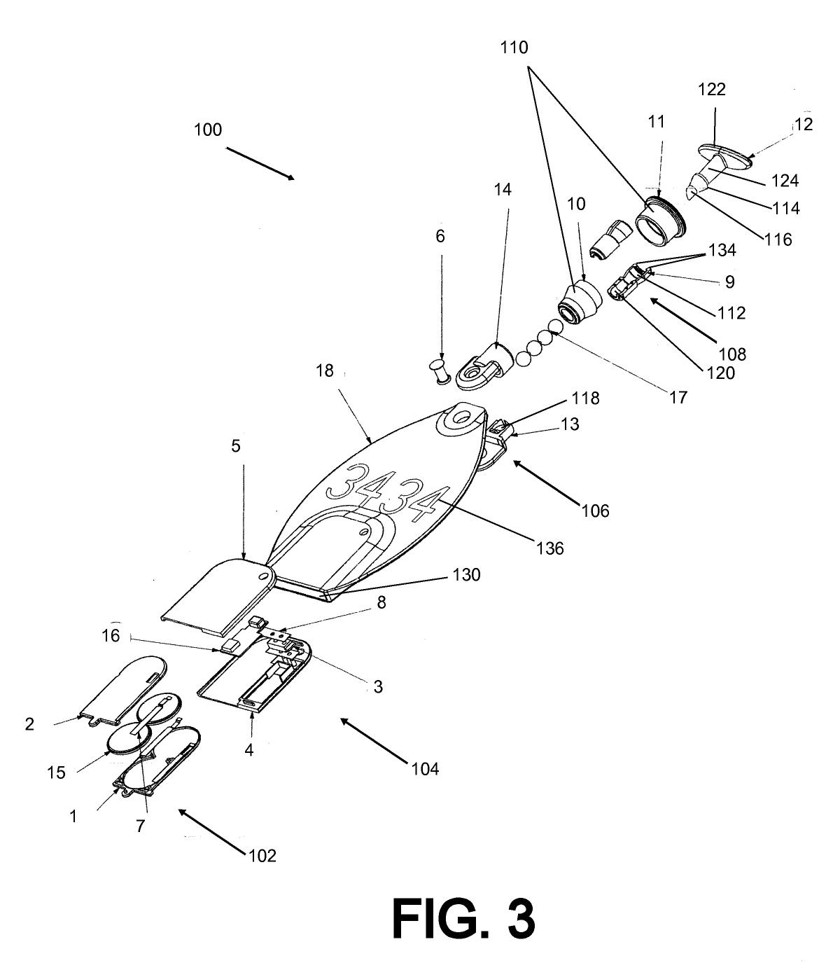

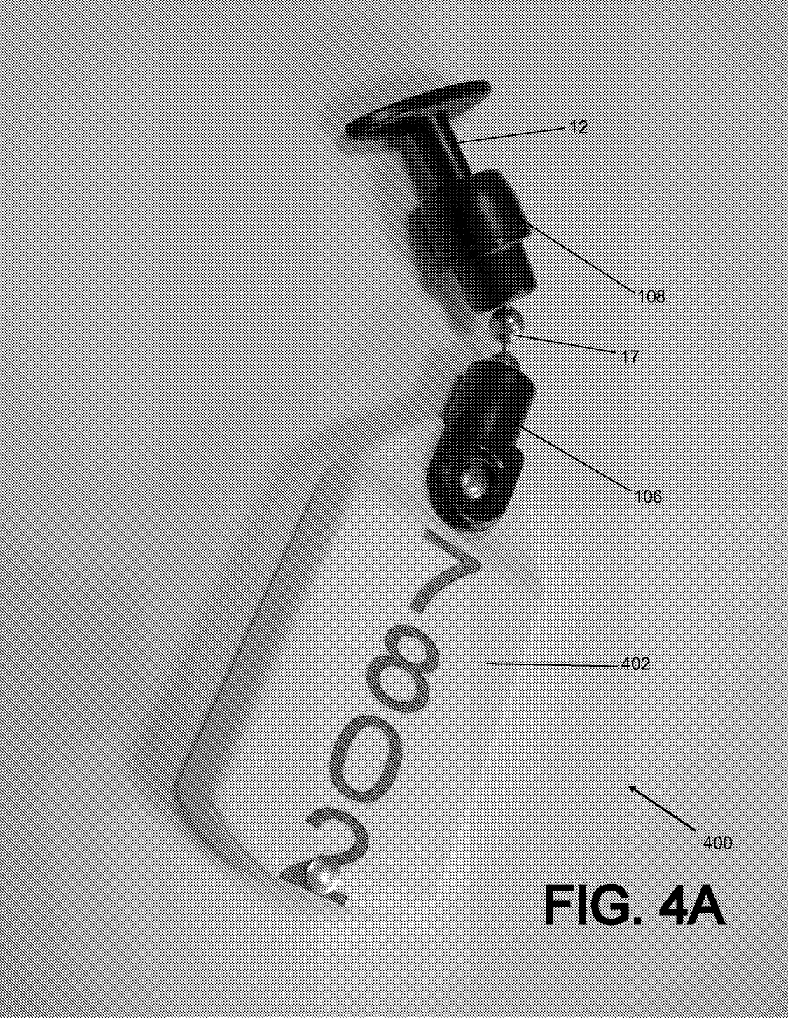

FIGS. 1-3 illustrate an ear tag system 100 according to embodiments of the present invention. FIG. 1 illustrates a front elevation view of ear tag system 100, FIG. 2 illustrates a side elevation view of ear tag system 100, and FIG. 3 illustrates an exploded perspective view of ear tag system 100, according to embodiments of the present invention. A battery 15 may be located within a battery enclosure 102, such as, for example, between a battery enclosure back 1 and a battery enclosure front 2. A battery enclosure contact 7 may also be located within battery enclosure 102. Battery 15 may be used to supply power to operate circuit board 16. As depicted in FIG. 3, for example, battery enclosure 102 and battery 15 may be located within an electrical enclosure 104, such as between electrical enclosure back 4 and electrical enclosure front 5. An electrical enclosure contact 8 and a contact spacer 3 may also be located within electrical enclosure 104, between electrical enclosure back 4 and electrical enclosure front 5.

Electrical enclosure 104 may, in turn, be housed within, affixed to, and/or coupled with tag 18. Tag 18 may include a hollow space 130 configured to house various electronic components that may be useful in livestock tracking and/or herd management, according to various embodiments of the present invention. Such components may be, for example, a battery, a computer chip, a circuit board, an antenna, a radio frequency identification (“RFID”) system, a global positioning system (“GPS”), and/or a multiple range identification (“MRID”) system. According to such embodiments of the present invention, circuit board 16 is portable within and as part of tag 18. Circuit board 16 may implement, but is not necessarily limited to, an MRID system, an RFID system, and/or a Global Positioning System (“GPS”) unit. For example, electrical enclosure 104 may include an MRID transmitter and/or transceiver and may be used with an MRID system as described in U.S. patent application Ser. No. 10/940,185, entitled “Mobile RFID Management Method and System,” filed on Sep. 13, 2004, and published as U.S. Patent Application Publication No. 2004/0088304, such application is hereby incorporated by reference in its entirety for all purposes.

At other end of tag 18, as depicted in FIG. 3, a system may be provided for attaching tag 18 to an animal. According to some embodiments, tag 18 may be attached to the ear of an animal. Although tag 18 and methods for applying tag 18 may be described with reference to bovine and cattle, tag 18 may alternatively be used to track livestock, wildlife, or other forms of animal life, according to embodiments of the present invention. A tag coupler 106 may include a tag coupler back 13 and a tag coupler front 14; tag coupler front 14 may be placed over tag 18 and tag coupler back 13 may be placed under tag 18, and a rivet 6 may be secured through a hole in tag coupler front 14, through a hole in tag 18, and through a hole in tag coupler back 13, as illustrated in FIG. 3. Tag coupler front 14 and tag coupler back 13 may alternatively be attached to each other and/or to tag 18 via an adhesive or an adhesive-like substance, for example. Based on the disclosure provided herein, one of ordinary skill in the art will recognize various alternative means for attaching tag coupler front 14 and tag coupler back 13 to each other and/or to tag 18. According to some alternative embodiments of the present invention, tag coupler 106 is formed integrally with tag 18. Tag coupler 106, together with tag 18, may also be referred to as a tag portion.

Tag coupler 106 couples tag 18 with ball chain 17. Ball chain 17 permits a degree of rotation, swiveling, and flexing of itself while maintaining a strong connection. Ball chains are known in the art. Ball chain may be, for example, a ¼ inch diameter ball chain, and may be made of stainless steel, according to various embodiments of the present invention. According to some embodiments, tag coupler 106 has formed therein a ball chamber 118, configured to retain a ball of ball chain 17 while permitting an end ball of ball chain 17 to rotate and/or swivel. In some embodiments, an end ball of ball chain 17 may be inserted into ball chamber 118, between tag coupler front 14 and tag coupler back 13, before tag coupler front 14 and tag coupler back 13 are attached to each other and/or tag 18, such that ball chain 17 is held within the ball chamber 118 of tag coupler 106 after tag coupler 106 has been secured to tag 18, thus permitting ball chain 17 to be rotatably coupled with tag 18. In other embodiments, an end ball of ball chain 17 may be inserted into the ball chamber 118 of tag coupler 106 after tag coupler front 14 and tag coupler back 13 have been attached to each other and/or tag 18, and the ball chamber 118 may be configured to permit such insertion but to resist disengagement of ball chain 17 from tag coupler 106, thereby permitting an end of ball chain 17 to rotate and/or swivel within, but not disengage from, tag coupler 106. According to some embodiments of the present invention, ball chain 17 may withstand up to 125 pounds of weight applied thereto.

Although FIGS. 1-3 depict a flexible connector 17 between tag 18 and keeper 108 in the form of a ball chain 17, other flexible connectors 17 may alternatively be used instead of ball chain 17. For example, a wire, a cable, a rope, a string, and/or a chain may be used as flexible connector 17 instead of a ball chain. According to such embodiments, flexible connector 17 may still comprise a ball-and-socket type joint which permits rotation and swiveling at one or more ends of flexible connector 17.

At other end of ball chain 17, a keeper sleeve 110 houses a keeper 108. Keeper sleeve 110 may include a keeper sleeve bottom 10 and a keeper sleeve top 11. Keeper 108 may also include two halves, and may include a ball chamber 120 formed therein. Keeper 108 may also include a receptacle 112 configured to receive an end 116 of pierce 12. An end ball of ball chain 17 may be placed within ball chamber 120, and the two halves of keeper 108 may be closed around the end ball of ball chain 17. The two halves of keeper 108 may be attached together with adhesive, clips, screws, and/or another attachment means; alternatively, the two halves of keeper 108 may be held together by the limited inner diameter of keeper sleeve bottom 10 and/or keeper sleeve top 11. Keeper 108, along with keeper sleeves 110, may be referred to as a keeper portion.

Keeper 108 may be inserted between keeper sleeve bottom 10 and keeper sleeve top 11, and keeper sleeve bottom 10 may be attached together with keeper sleeve top 11, such as with adhesive, clips, screws, and/or another attachment means. Pierce 12, as depicted in FIG. 3, includes head 122, a shaft 124, a protruding lip 114, such as a conical protrusion 114, and an end 116 which may be sharpened. Once end 116 of pierce 12 has been placed through an ear, for example, end 116 of pierce 12 may then be pushed through the top opening of keeper sleeve top 11 and into receptacle 112 of keeper 108. Receptacle 112 may be configured to permit entry of end 116 and protrusion 114 on shaft 124, while resisting disengagement of protrusion 114 and thus pierce 12 from receptacle 112 of keeper 108. In this way, pierce is deterred and/or prevented from becoming detached from keeper 108, which is in turn coupled with ball chain 17, which is in turn coupled with tag coupler 106, which is in turn coupled with tag 18.

According to some embodiments of the present invention, the two halves of keeper 108 spread upon entry of conical end 116 and protrusion 114, to permit engagement of protrusion or protruding lip 114 with keeper 108, while thereafter deterring disengagement of protrusion 114 from keeper 108 via the shape of receptacle 112 and/or the limited inner diameter of keeper sleeve bottom 10 and/or keeper sleeve top 11. Keeper 108 may include, according to some embodiments, a collar 134. The conical shape of end 116 may permit end 116 to slide past collar 134 of keeper 108 until protruding lip 114 passes collar 134, at which time protruding lip 114 contacts collar 134 to resist disengagement of pierce 12 from the keeper portion. According to some embodiments of the present invention, system 100 is designed such that once pierce 12 has been locked into and/or engaged with keeper 108 and thus tag 18, tag 18 may not be removed from ear without destruction of tag 18 and/or the animal's ear. According to such embodiments, system 100 may include such tamper-proof characteristics.

Tag 18 may be made with resin, such as, for example, a laser markable resin, according to various embodiments of the present invention. A laser marking process may be used to imprint information onto tag 18 such as, for example, a number 136 and/or a bar code.

The materials out of which elements of system 100 may be constructed may vary. According to some embodiments of the present invention, and for example, battery enclosure back 1, battery enclosure front 2, contact spacer 3, electrical enclosure back 4, and electrical enclosure front 5 may be constructed with plastic, such as ABS; rivet 6 may be constructed with aluminum; contacts 7, 8 may be constructed with copper; keeper 108, keeper sleeve 110 and tag coupler 106 may be constructed with an acetal resin, such as Delrin® (made by DuPont), and tag 18 may be constructed of plastic, wood, metal, resin, or other durable material.

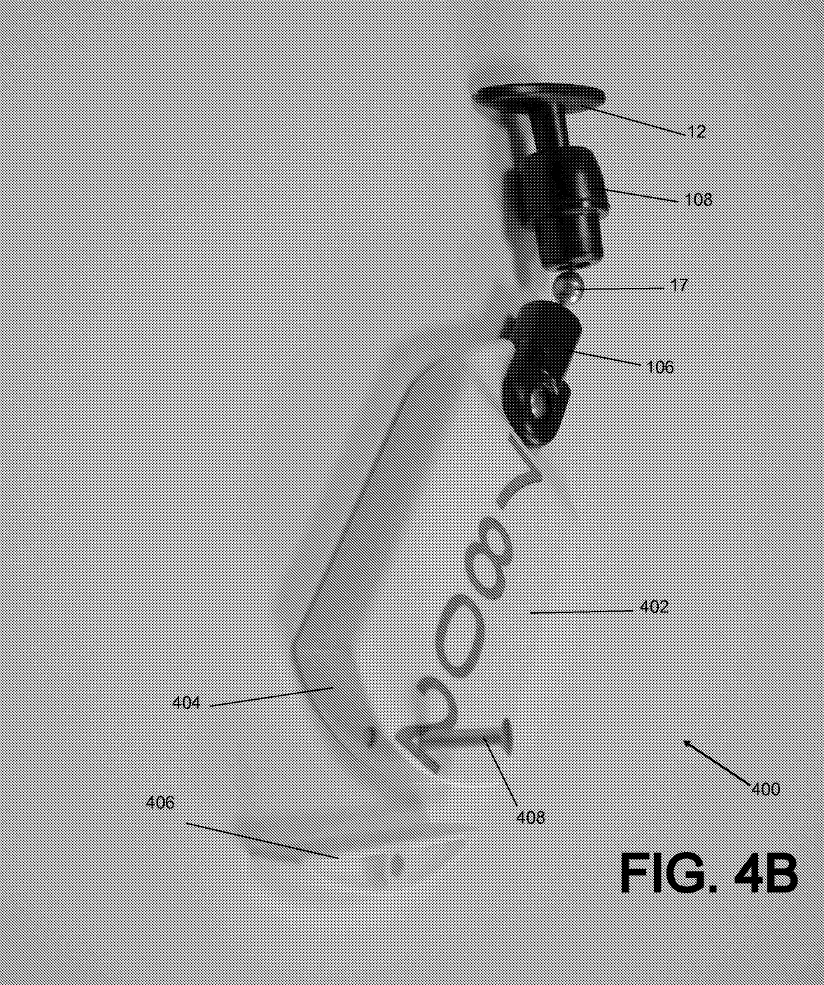

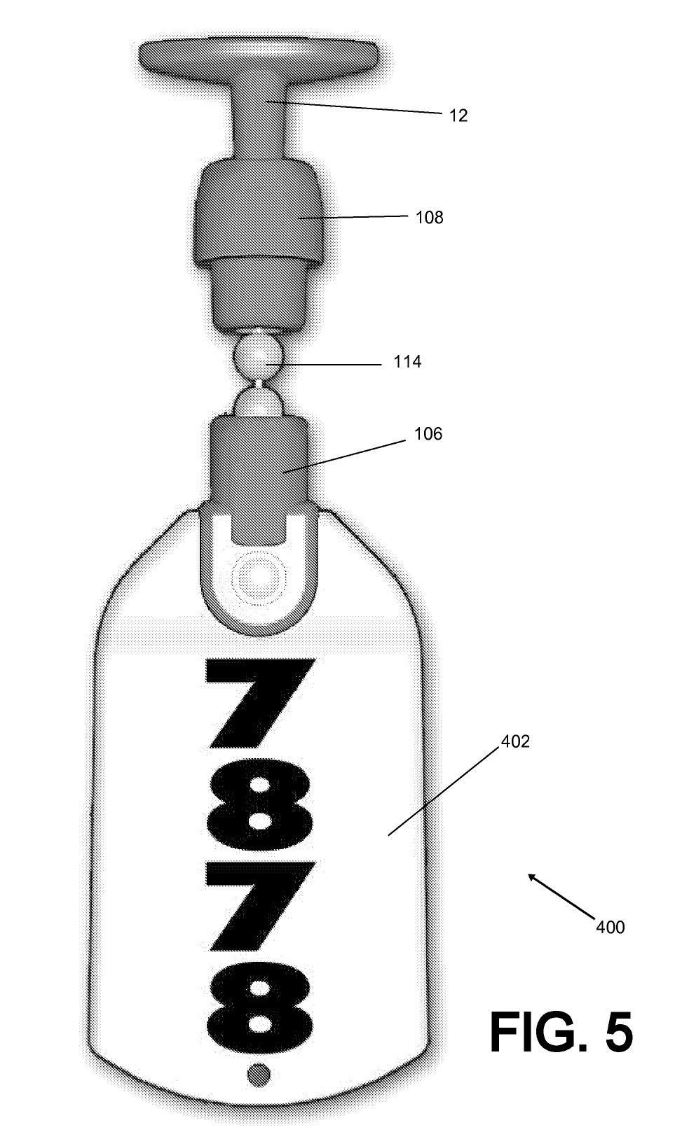

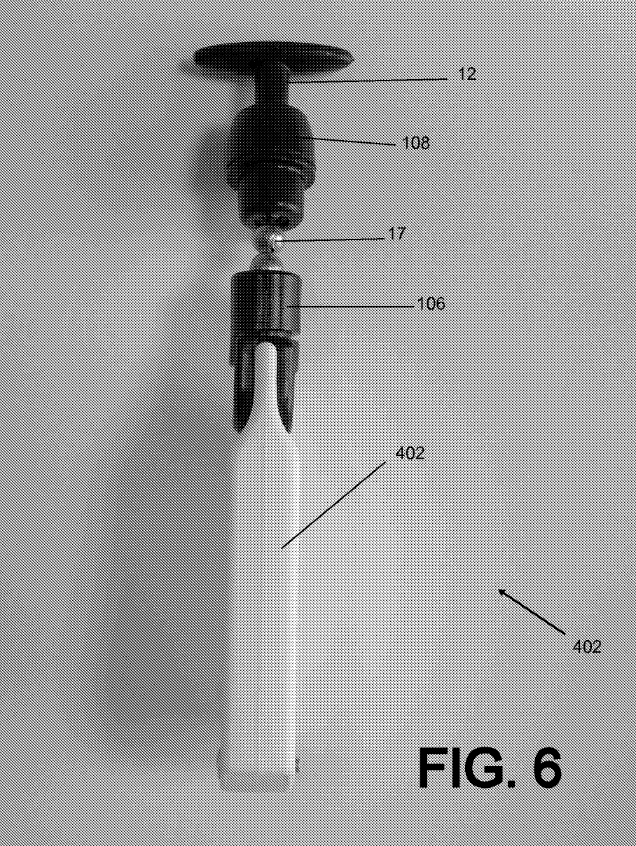

FIGS. 4A-6 depict an alternative embodiment of an ear tag system 400 according to some embodiments of the present invention. FIGS. 4A & 4B illustrate perspective views, FIG. 5 illustrates a front elevation view, and FIG. 6 illustrates a side elevation view of an ear tag system 400 according to embodiments of the present invention. Ear tag system 400 may employ a tag coupler 106, a connector 17, a keeper 108 or keeper portion, and a pierce 12 similar to those of ear tag system 100 of FIGS. 1-3. However, ear tag system 400, as depicted, includes a tag 402 having a larger hollow opening for receiving electronics. FIG. 4B shows ear tag system 400 with end cap 406 removed, revealing hollow space 404. End cap 406 may normally be held in place on tag 402 via a rivet 408; sliding rivet 408 out of tag 402 may permit removal of end cap 406.

Although hollow opening 404 is described herein as hollow, opening 404 may optionally be filled with electronics or other desired equipment or fillers, and thus would no longer be hollow 404 after such filling. Therefore, as used herein to describe a tag 18 or 402 or 1220, “hollow” is used in its broadest sense to refer to an opening that would permit insertion of electronic devices or other fillers, whether or not such hollow opening is in fact used to house such electronic devices or other fillers.

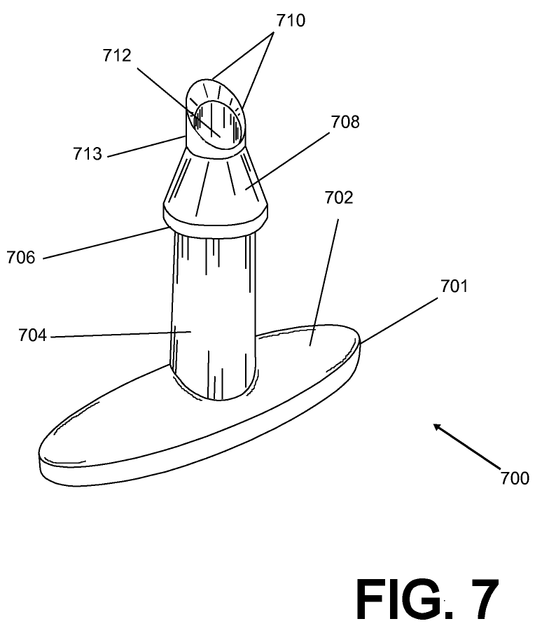

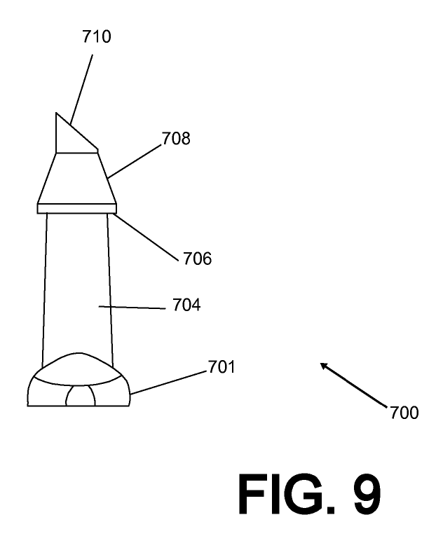

FIGS. 7-10 depict a pierce 700 according to some embodiments of the present invention. According to some embodiments, pierce 700 is hollow. Pierce 700 may have a head 701, a shaft 704, a conical portion 708 with a protruding lip 706, and a cutting edge 710. Pierce 700 may be applied through an animal's ear, for example, manually or through the use of a tool. Such a tool may be, for example, a tool similar to a pliers, with one grip of the pliers pushing the head 701 of pierce 700 down through the ear, and the other grip of the pliers resting under the ear to provide a balancing force. According to such embodiments, sharp end 710 and hollow shaft 704 of pierce 700 cuts a hole through the ear, causing the circle of cut flesh to lodge within shaft 704, specifically within inner diameter 712 of shaft, and eventually necrose. Cutting a clean hole through the ear via cutting edge 710 may further prevent infection as compared with a pierce-like device which simply spreads and tears the ear flesh as it passes through. Alternatively, a hole punch tool may be used to punch a hole in the ear prior to insertion of pierce 700 therethrough. A top surface 702 of head 701 may be contoured to fit an animal's ear according to some embodiments of the present invention.

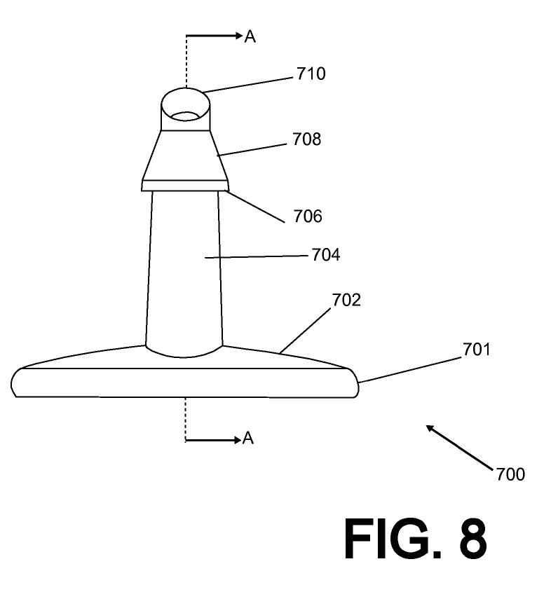

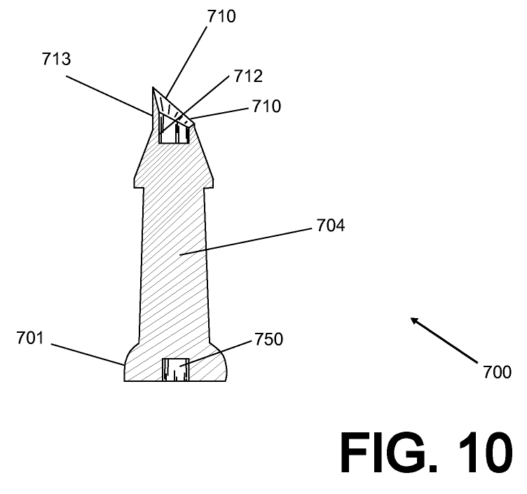

FIG. 10 depicts a cross section of pierce 700 taken along line A-A of FIG. 8, which illustrates how cutting edge 710 may be formed by sloping the shaft 704 from inner diameter 712 to outer diameter 713. Such a slope creates a sharpened edge along outer circumference 710 of the top end of shaft 704. A hole 750 may also be formed in head 701; such hole 750 may be used to receive a driving end of a tool that may be used for pushing pierce 700 through the animal's ear, according to some embodiments of the present invention.

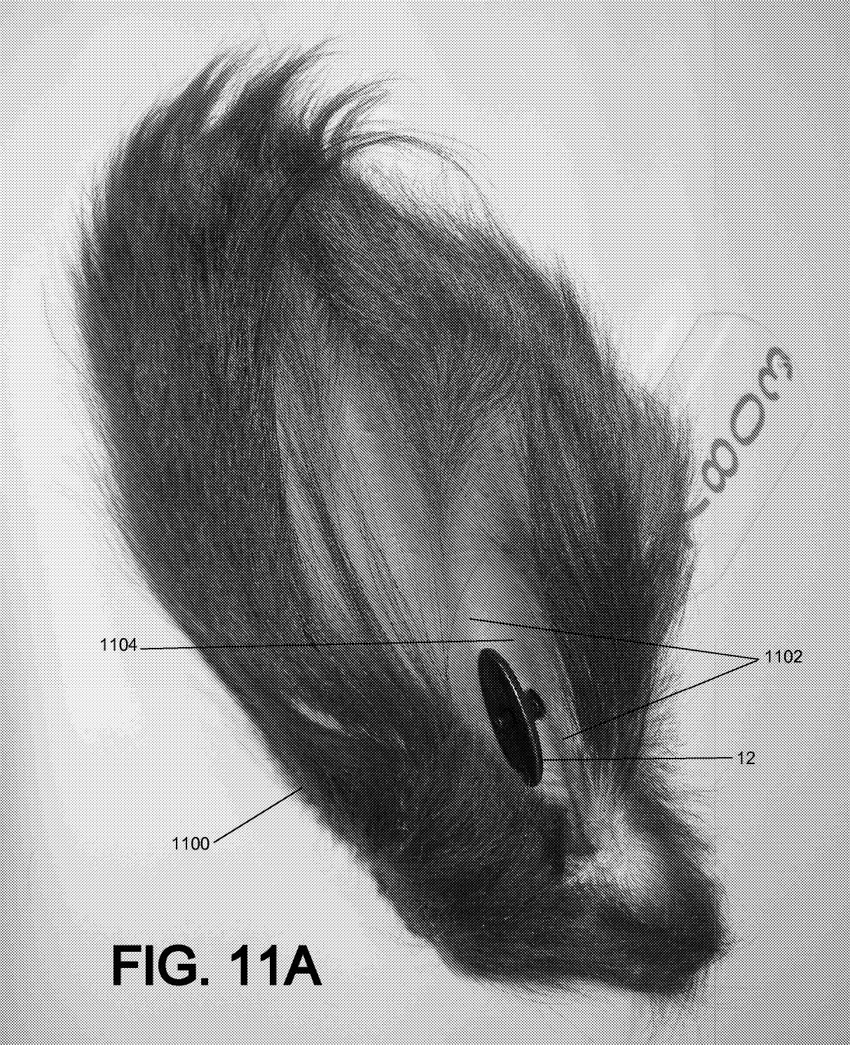

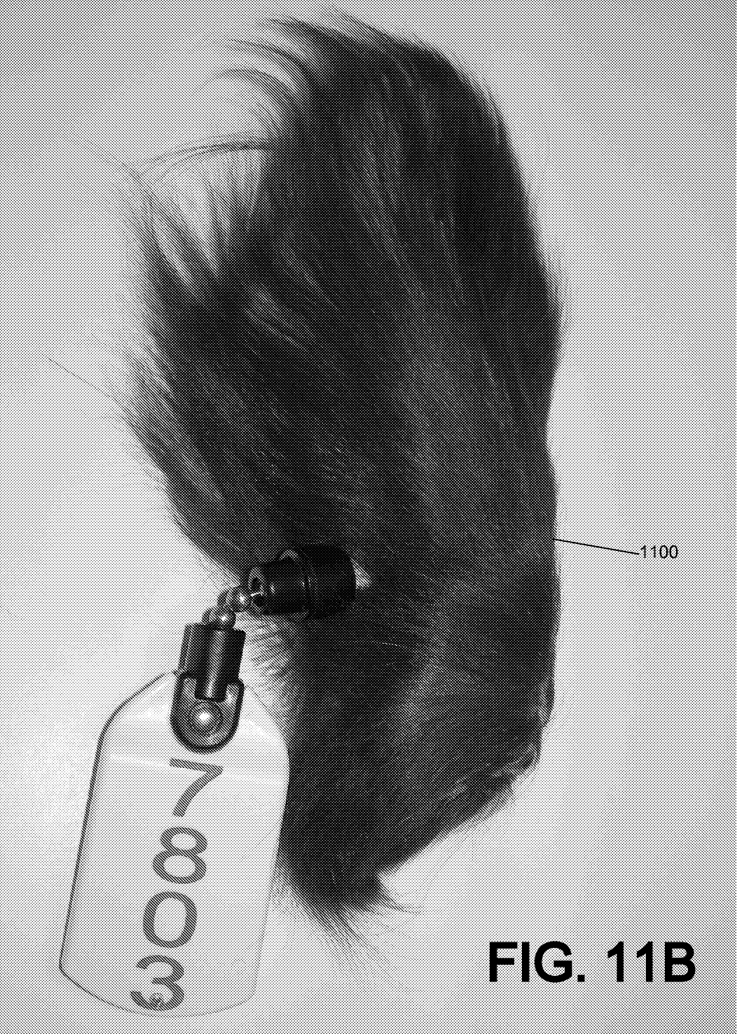

FIGS. 11A and 11B illustrate an exemplary placement of the ear tag 400 of FIGS. 4A-6 on a bovine ear according to embodiments of the present invention. Pierce 12 of ear tag system 400 may be attached inside the lower section of the ear 1100 close to the head of the animal where the ear is attached to the skull, such as, for example, the deep trough 1104 between two bands 1102 or folds of ear cartilage that extend horizontally outwardly from the head. Such a placement of pierce 12 helps ensure that tag 18 is attached to the area of the ear that provides the greatest anatomical strength as well as the greatest resistance to detachment as the result of applied force. According to some embodiments of the present invention, pierce 12 is hidden inside the ear and is not exposed to exterior hazards such as wire, vegetation, and animal activities such as rubbing and scratching against other objects. In addition, the wider shape of head 122, 701 and the thickness of shaft 124, 704 provide a larger holding area through the ear, as well as a larger area over which any force applied to pierce 12, 700 such as a tugging force, is applied. Other embodiments of ear tags described herein may be similarly attached at a similar location in the ear.

Once pierce 12, 700 has been placed through the ear and engaged with keeper 108, tag 18 hangs from the ear and is permitted to turn, swivel, and curve with respect to pierce 12, 700 by ball chain 17. This property of system 100, 400 may further prevent tag 18, 402 from becoming caught or tangled on another object or on the subject animal, which may result in decreased tearing or other damage to the subject animal, as well as increased longevity and durability of tag 18 and decreased damage to other objects. The multiple swivel and rotational points permitted by such a design provide a wide range of motion for tag 18 and subject animal, thus greatly lessening the chance of detachment or destruction of tag 18. Tag 18 also does not significantly protrude on both sides of the same ear, thus minimizing the chances for the tag to catch on external objects. Such advantages apply also to other ear tag system embodiments disclosed herein.

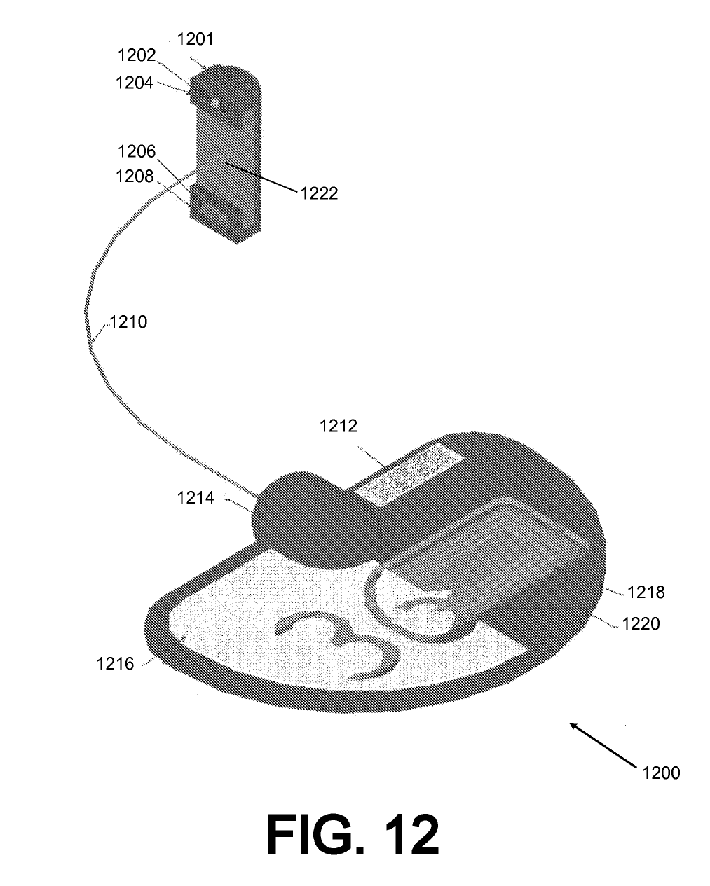

FIGS. 12-15 illustrate an alternative ear tag system 1200 according to embodiments of the present invention. Ear tag system 1200 includes a locking clip 1201 with a battery pocket 1202 and first pocket door 1204, a temperature chip pocket 1206 and second pocket door 1208. Such optional embodiments of locking clip 1201 may include, for example, a temperature sensor assembly, a GPS chipset assembly, or other sensor assemblies capable of monitoring heartbeat, respiration, and other animal metabolic measurements. Locking clip 1201 may be connected with tag 1220 by a flexible connector 1210. Flexible connector 1210 may be, for example, a stranded cable, such as a 1×7 construction nylon coated stranded cable according to some embodiments of the present invention. The other end of flexible connector 1210 may be rotatably coupled with tag 1220 via a ball-and-socket joint. Socket 1214 may be seen in FIG. 12. Tag 1220 as depicted may also include a white lamination 1216 with cut-out identification numbers, and/or a bar code 1212. Tag 1220 may also include a hollow portion 1218 which may be configured to house electronics, such as, for example, a transponder. According to some embodiments, locking clip 1201 may be completely hidden inside the ear and thus not exposed to external hazards such as, for example, wire, vegetation, and animal activities such as rubbing and scratching against other objects.

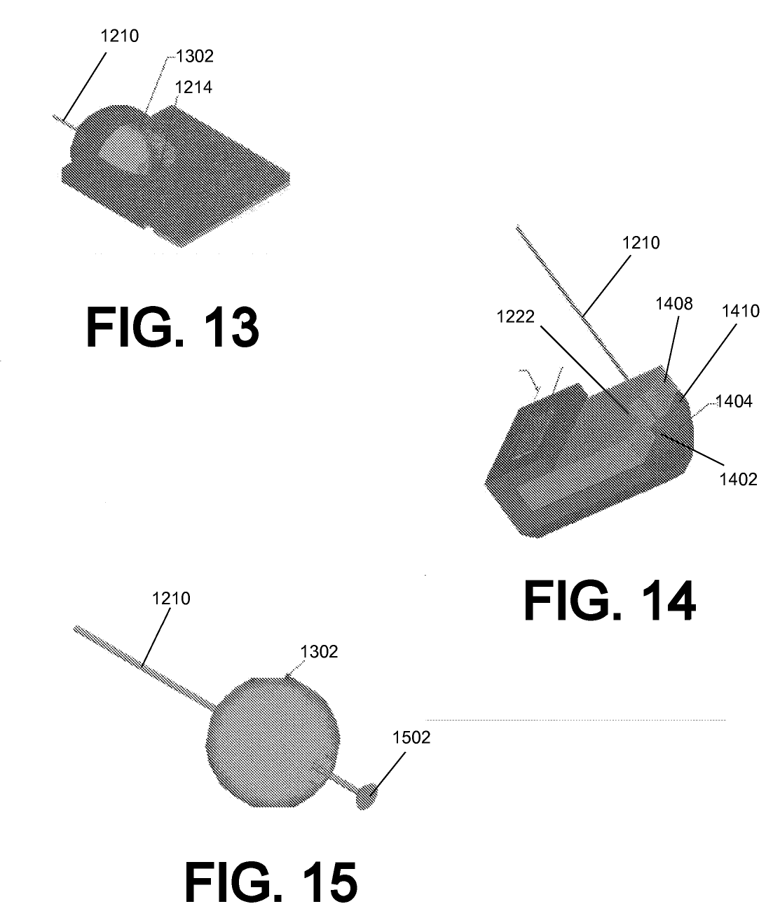

FIG. 13 illustrates a partial backside view of ear tag system 1200, showing socket 1214 and ball 1302 attached to cable 1210. FIG. 15 provides a detailed view of ball 1302 and an example of how ball 1302 may be attached to cable 1202. A stopper 1502 may be formed on the end of cable 1210 or attached with the end of cable 1210, and configured to prevent ball 1302 from sliding off of cable 1210. The end of cable 1210 opposite stopper 1502 may be easily be fed through socket 1214 and pulled until ball 1302 contacts socket 1214, thus permitting rotation of ball 1302 and thus cable 1210 within socket 1214. According to some embodiments of the present invention, cable 1210 is permanently molded into ball 1302, socket 1214, and/or tag 1220.

FIG. 14 illustrates a partial perspective cross sectional view of locking clip 1201, according to embodiments of the present invention. Locking clip 1201 may include a first half 1408 and a second half 1410, according to embodiments of the present invention. Locking clip 1201 may be, for example, one inch long by 0.4 inches in diameter, and designed such that cable 1210 may be retained within a locking clip and cone similar to that described with respect to system 1600. Such a design characteristic may ensure that any forces exerted against locking clip 1201 may be distributed over a large area, and that detachments and tears of the ear may be further deterred.

The end of cable 1210 which interfaces with locking clip 1201 may include a toggle 1402, which may be a T-shaped element on the end of cable 1210. Once toggle 1402 and cable 1210 have been fed through ball 1302 and socket 1214, toggle 1402 may then be pushed and/or pierced through the ear of an animal, and then pushed through hole 1222 of first half 1408 of locking clip. First half 1408 may then be engaged with second half 1410, thus permitting toggle 1402 to rest between first half 1408 and second half 1410 within a toggle pocket 1404, according to embodiments of the present invention. Toggle pocket may optionally be a groove formed in first half 1408 and/or second half 1410. Such a holding groove can be capped or filled with an adhesive such that tampering or purposeful detachment is mitigated. Toggle 1402 may be substantially prevented from disengaging with locking clip 1201 by its placement and holding between first half 1408 and second half 1410. According to some embodiments of the present invention, first half 1408 slidably couples and/or slidably engages with second half 1410. Many of the advantages described above with respect to ear tag systems 100, 400 also apply to ear tag system 1200 according to embodiments of the present invention.

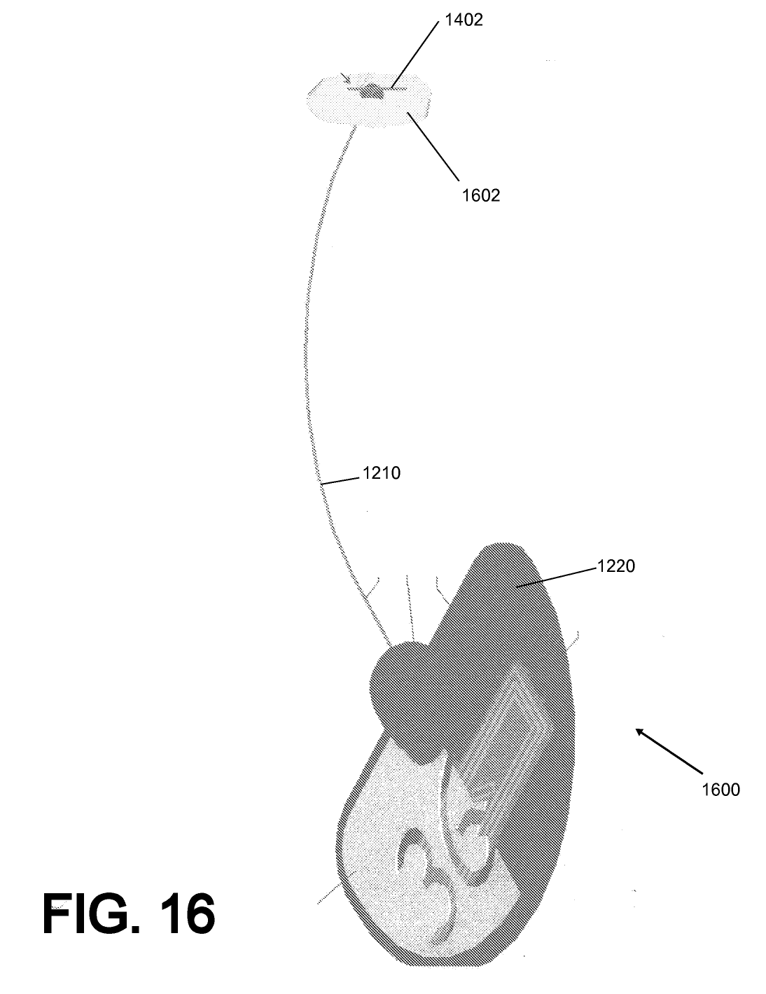

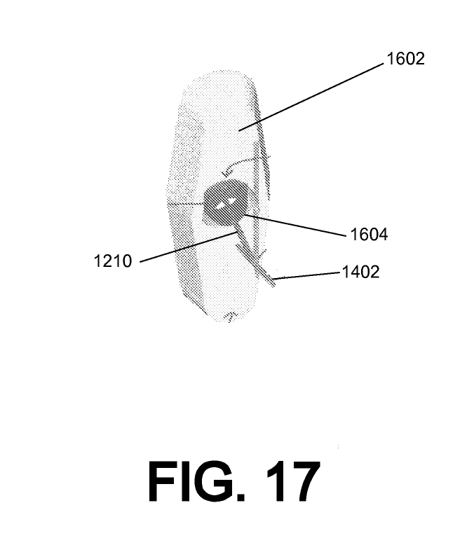

FIGS. 16-17 illustrate an alternative ear tag system 1600 according to embodiments of the present invention. Ear tag system 1200 includes an alternative locking clip 1402 according to various embodiments of the present invention, while components of the tag 1220 may resemble components of system 1200 of FIGS. 12-15. Locking clip 1402 is shown in greater detail in FIG. 17. Locking clip 1402 may include a fluted cone 1604 through which toggle 1402 may pass. Toggle 1402 may either pass through locking clip 1402 in the direction shown in FIGS. 16-17, or toggle 1402 may preferably pass through locking clip 1402 opposite the direction shown in FIGS. 16-17. In order to use locking clip 1402, locking clip 1402 may first be placed on an inside of an animal's ear at the desired piercing or puncturing position. Locking clip 1402 may then be placed up against inside of the ear such that fluted cone 1604 may be seen through the ear and/or such that fluted cone 1604 may be pushed enough to cut through the ear.

According to some embodiments of the present invention, pressure may be applied to the ear on one side and the locking clip 1402 on the other side to facilitate the cutting of a hole with fluted cone 1604; for example, a pliers may be used to push the fluted cone 1604 through the ear. Once a hole has been cut through the ear via fluted cone 1604 or otherwise, toggle 1402 may be passed through the ear and through fluted cone 1604 (preferably in the direction opposite that shown in FIGS. 16-17). Once toggle 1402 has passed through fluted cone 1604, the opposite side of locking clip 1402 may include a groove in which toggle 1402 may rest to deter disengagement of cable 1210 from locking clip 1602. Toggle 1402 may be configured such that it may be passed or threaded through smaller holes by bending cable 1210 where cable 1210 meets toggle 1402 until toggle 1402 is substantially parallel with cable 1210, while releasing toggle 1402 will permit toggle 1402 to return to its normal T-shape to deter disengagement from locking clip 1602. The fluted cone 1604 shape of locking clip 1602 may protect cable 1210 from applying any pulling or tearing pressures directly against the ear of the animal, resulting in decreases in tears and ear infections and superior retention.

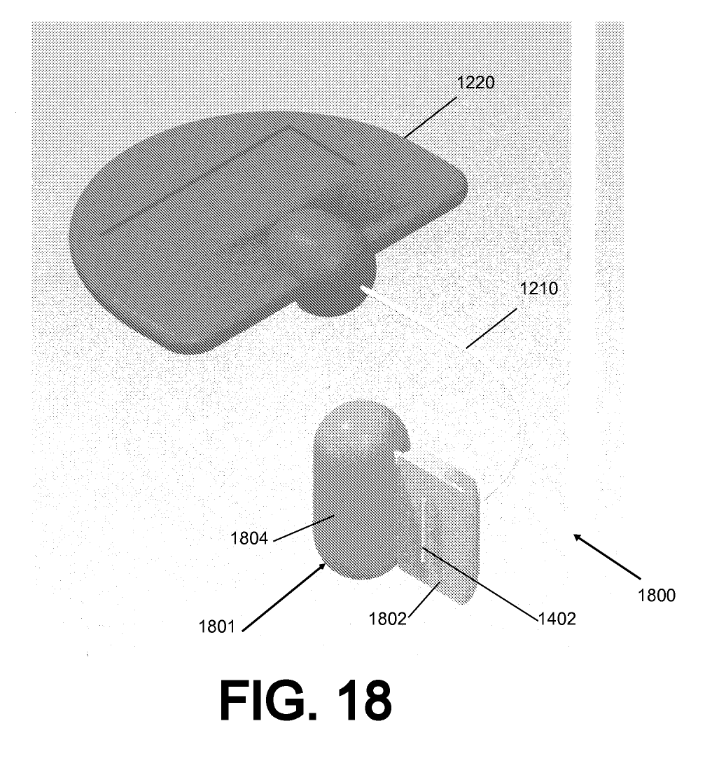

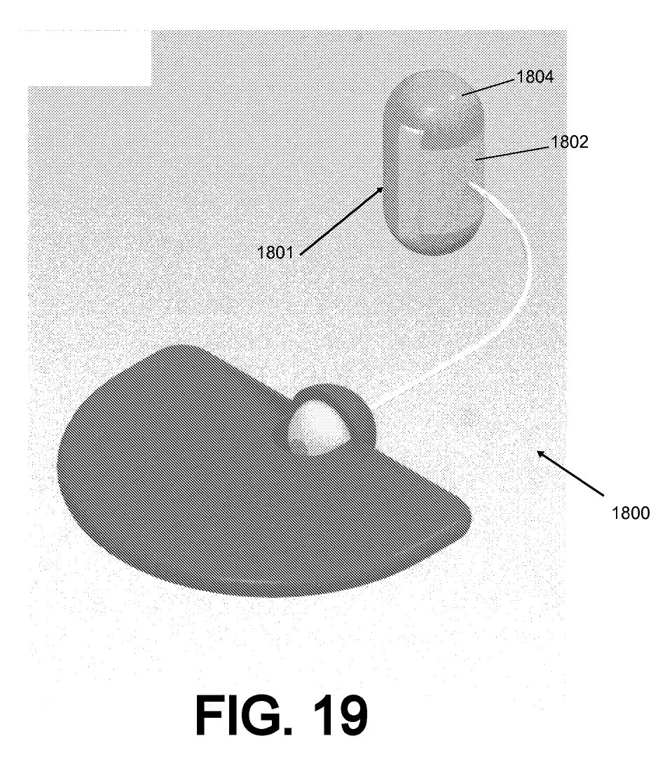

FIGS. 18 and 19 illustrate yet another alternative embodiment of an ear tag system 1800 according to various embodiments of the present invention. Similarly to ear tag system 1200, a locking clip 1801 has a first half 1802 and a second half 1804, and the first half 1802 may be slidably coupled with the second half 1804. Tag 1220 may be coupled with the locking clip 1801 via a connector portion 1210 such as, for example, a cable. Tag 1220 may be rotatably coupled with connector portion 1210 via a ball-and-socket type joint as previously described, and as seen in FIG. 19. Toggle 1402 may be threaded through an animal ear and then through first half 1802. First half 1802 may then be slidably coupled with second half 1804 to hold toggle 1402 between first half 1802 and 1804, to further prevent disengagement of toggle 1402 from the locking clip 1801. Many of the advantages described above with respect to ear tag systems 100, 400, 1200, and 1600 also apply to ear tag system 1800 according to embodiments of the present invention.

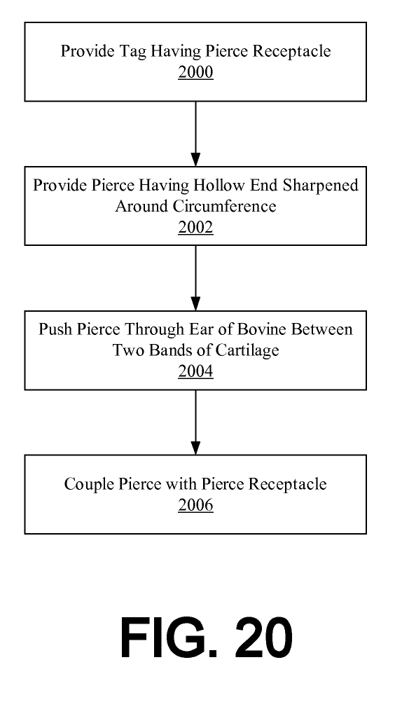

FIG. 20 illustrates a flow diagram of a method for applying an ear tag to an ear, according to embodiments of the present invention. A tag 18 may be provided, the tag having a pierce receptacle 112, the pierce receptacle 112 rotatably coupled to the tag 18 (block 2000). A pierce 12 may be provided, the pierce 12 having a hollow end 116, the hollow end 116 sharpened around its circumference (block 2002). The pierce 12 may be pushed through an ear of a bovine at a location on an inside of the ear in a trough 1104 between two bands of cartilage 1102, thereby cutting a hole through the ear with the hollow end (block 2004). Finally, the pierce 12 may be coupled with the pierce receptacle 112, to prevent pierce 12 and thus tag 18 from disengaging with the ear (block 2006).

As can be seen from the above description, several elements of various embodiments of the present invention are standard, interchangeable, interconnectable, and/or modular for increased manufacturing and installation efficiency. Embodiments of the invention have now been described in detail for purposes of clarity and understanding. However, it will be appreciated that certain changes and modifications may be practiced within the scope of the appended claims. Thus, although the invention is described with reference to specific embodiments and figures thereof, the embodiments and figures are merely illustrative, and not limiting of the invention. Rather, the scope of the invention is to be determined solely by the appended claims.

What is claimed is:

1. An ear tag comprising:
a tag portion;
a flexible connector portion with a first end and a second end, the first end rotatably coupled to the tag portion;
a keeper portion rotatably coupled to the second end; and
a piercing portion configured to engage the keeper portion, the piercing portion comprising a cutting edge for insertion through an ear of an animal.

2. The ear tag of claim 1, wherein the flexible connector portion is a ball chain.

3. The ear tag of claim 2, wherein the ball chain is configured to permit flexing of the ball chain with respect to the tag portion and the keeper portion.

4. The ear tag of claim 2, wherein the ball chain is configured to permit rotation and swiveling of the ball chain with respect to the tag portion and the keeper portion.

5. The ear tag of claim 2, wherein the ball chain is configured to carry at least 125 pounds of axial tension.

6. The ear tag of claim 1, wherein the tag portion comprises a hollow portion.

7. The ear tag of claim 6, wherein the hollow portion is configured to receive an electronic device selected from the group consisting of: an electronic tracking system, a battery, and an electronic chip.

8. The ear tag of claim 1, wherein the animal is bovine.

9. The ear tag of claim 1, wherein the piercing portion further comprises:
a head; and
a shaft portion having a head end and a cutting end, the head end connected to the head, the cutting end comprising the cutting edge.

10. The ear tag of claim 9, further comprising:
a lip formed on the shaft portion and configured to engage a collar on the keeper portion.

11. The ear tag of claim 9, wherein the cutting end is hollow.

12. The ear tag of claim 9, wherein one side of the cutting edge protrudes further from the head than another side of the cutting edge.

13. The ear tag of claim 9, wherein the cutting edge is a sharpened circumference of the shaft portion.

14. The ear tag of claim 9, wherein the head is contoured to the ear and configured to disperse a force applied to the ear tag over an area of the ear.

15. The ear tag of claim 9, wherein the cutting edge is configured to cleanly remove a circle of flesh from the ear.

16. The ear tag of claim 1, further comprising a bar code or a number applied to the tag portion.

17. The ear tag of claim 16, wherein the tag portion is made with resin, and wherein the bar code or the number is laser marked onto the resin.

18. The ear tag of claim 1, wherein the flexible connector portion is a cable.

19. The ear tag of claim 1, wherein the tag portion comprises a ball chamber, and wherein the first end is rotatably coupled with the tag portion via the ball chamber.

20. The ear tag of claim 1, wherein the keeper portion comprises a ball chamber, and wherein the second end is rotatably coupled with keeper portion via the ball chamber.

21. An ear tag comprising:
a tag portion;
a flexible connector portion with a first end and a second end, the first end rotatably coupled to the tag portion, the second end configured to pierce an ear;
a locking clip configured to engage the second end on a side of the ear opposite from the tag portion.

22. The ear tag of claim 21, wherein the locking clip comprises a fluted cone for facilitating placement of the second end through the ear and through the locking clip.

23. The ear tag of claim 22, wherein the second end comprises a toggle, and wherein the locking clip comprises a groove for engaging the toggle.

24. The ear tag of claim 21, wherein the second end comprises a toggle, and wherein the locking clip comprises a first half and a second half, the toggle configured for insertion through the first half and retention between the first half and the second half.

25. The ear tag of claim 24, wherein the second half comprises a toggle pocket, and wherein the second half slides over the first half to retain the toggle within the toggle pocket between the first half and the second half.

26. The ear tag of claim 21, wherein the locking clip comprises a device selected from the group consisting of: a battery and a temperature chip.

27. A method for attaching an ear tag to an animal, the method comprising:
providing a tag having a pierce receptacle, the pierce receptacle rotatably coupled to the tag;
providing a pierce having a hollow end, the hollow end sharpened around its circumference;
pushing the pierce through an ear of an animal at a location on an inside of the ear in a trough between two bands of cartilage, thereby cutting a hole through the ear with the hollow end; and
coupling the pierce with the pierce receptacle.

28. The method of claim 27, wherein the pierce comprises a protruding lip, and wherein coupling the pierce with the pierce receptacle comprises engaging the protruding lip with the pierce receptacle.

29. The method of claim 28, wherein the pierce receptacle comprises a collar, and wherein engaging the protruding lip with the pierce receptacle comprises engaging the protruding lip with the collar.

30. The method of claim 29, wherein the pierce tapers from the hollow end to the protruding lip, and wherein engaging the protruding lip with the collar comprises pushing the hollow end through the collar to expand the collar until the protruding lip passes through the collar.

31. The method of claim 27, wherein the animal is a bovine.
